(19) United States
(12) Patent Application Publication
(10) Pub. No.: US 2025/0219898 A1
(43) Pub. Date: Jul. 3, 2025

(54) :USER EQUIPMENT REPORT OF MACHINE LEARNING MODEL PERFORMANCE

(71) Applicant: TELEFONAKTIEBOLAGET LM ERICSSON (PUBL), Stockholm (SE)

(72) Inventors: Jingya Li, Göteborg (SE); Mårten Sundberg, Stockholm (SE); Daniel Chen Larsson, Lund (SE); Adrian Garcia Rodriguez, Massy (FR); Emil Ringh, Stockholm (SE); Icaro Leonardo Da Silva, Stockholm (SE); Yufei Blankenship, KILDEER, IL (US)

(21) Appl. No.: 18/848,380

(22) PCT Filed: Mar. 29, 2023
(86) PCT No.: PCT/US2023/016770

§ 371 Date: Sep. 18, 2024

Related U.S. Application Data
(60) Provisional application No. 63/325,013, filed on Mar. 29, 2022.

(51) Int. Cl. H04L 41/0803; H04L 41/16

(52) U.S. Cl. CPC H04L 41/0803; H04L 41/16

(57) ABSTRACT

The present disclosure describes a method performed by a user equipment (UE) for reporting the performance of at least one machine-learning (ML) model to a cellular telecommunications network. Some exemplary embodiments include the UE utilizing at least one ML model, generating one or more reports or reportable information of a performance of the at least one ML model, and reporting the one or more reports or reportable information to a network. Associated devices and systems are also provided herein.

### CROSS REFERENCE TO RELATED INFORMATION

This application claims the benefit of U.S. Provisional Application No. 63/325,013 filed on Mar. 29, 2022, titled “UE REPORT OF ML-MODEL PERFORMANCE,” which is hereby incorporated in its entirety.

### TECHNICAL FIELD

The present disclosure generally relates to the technical field of wireless communications and more particularly to machine learning model monitoring and reporting.

### BACKGROUND

Artificial Intelligence (AI), Machine Learning (ML) have been investigated as promising tools to optimize the design of air-interface in wireless communication networks in both academia and industry. Example use cases include using autoencoders for CSI compression to reduce the feedback overhead and improve channel prediction accuracy; using deep neural networks for classifying LOS and NLOS conditions to enhance the positioning accuracy; and using reinforcement learning for beam selection at the network side and/or the UE side to reduce the signaling overhead and beam alignment latency; using deep reinforcement learning to learn an optimal precoding policy for complex MIMO precoding problems.

In 3GPP NR standardization work, there will be a new release 18 study item on AI/ML for NR air interface starting in May 2022. This study item will explore the benefits of augmenting the air-interface with features enabling improved support of AI/ML based algorithms for enhanced performance and/or reduced complexity/overhead. Through studying a few selected use cases (CSI feedback, beam management and positioning), this SI aims at laying the foundation for future air-interface use cases leveraging AI/ML techniques.

When applying AI/ML on air-interference use cases, different levels of collaboration between network nodes and UEs can be considered:
No collaboration between network nodes and UEs. In this case, a proprietary AI/ML model operating with the existing standard air-interface is applied at one end of the communication chain (e.g., at the UE side). And the model life cycle management (e.g., model selection/training, model monitoring, model retraining, model update) is done at this node without inter-node assistance (e.g., assistance information provided by the network node).
Limited collaboration between network nodes and UEs. In this case, an AI/ML model is operating at one end of the communication chain (e.g., at the UE side), but this node gets assistance from the node(s) at the other end of the communication chain (e.g., a gNB) for its AI/ML model life cycle management (e.g., for training/retraining the AI/ML model, model update).
Joint AI/ML operation between network notes and UEs. In this case, it is assumed that the AI/ML model is split with one part located at the network side and the other part located at the UE side. Hence, the AI/ML model requires joint training between the network and UE, and the AI/ML model life cycle management involves both ends of a communication chain.

Here, AI/ML use cases are considered that fall into the category of limited collaboration between network nodes and UEs. It is assumed that a proprietary AI/ML model operating with the existing standard air-interface is placed at the UE side. The AI/ML model output is reported from the UE to the network. Based on this model output, the network takes an action(s) that affect(s) the current or/and subsequent wireless communications between the network and the UE.

As an example, a ML-based CQI (channel quality indicator) report algorithm is deployed at a UE. The UE uses this ML model to estimate the CQI values and report them to its serving gNB. Based on the received CQI report, the gNB performs link-adaptation, beam selection, or/and scheduling decisions for the next data transmission/reception to/from this UE.

Building an AI/ML model includes several development steps where the actual training of the AI model is just one step in a training pipeline. An important part in AI/ML developing is the AI/ML model lifecycle management. This is illustrated in FIG. 1. The AI model lifecycle management typically comprises:
A training (re-training) pipeline:
   a. With data ingestion referring to gathering raw (training) data from a data storage. After data ingestion, there may also be a step that controls the validity of the gathered data.
   b. With data pre-processing referring to some feature engineering applied to the gathered data, e.g., it may include data normalization and possibly a data transformation required for the input data to the AI/ML model.
   c. With the actual model training steps as previously outlined.
   d. With model evaluation referring to benchmarking the performance to some baseline. The iterative steps of model training and model evaluation continues until the acceptable level of performance (as previously exemplified) is achieved.
   e. With model registration referring to register the AI/ML model, including any corresponding AI/ML-meta data that provides information on how the AI/ML model was developed, and possibly AI/ML model evaluation performance outcomes.
A deployment stage to make the trained (or re-trained) AI/ML model part of the inference pipeline.
An inference pipeline:
   a. With data ingestion referring to gathering raw (inference) data from a data storage.
   b. With data pre-processing stage that is typically identical to corresponding processing that occurs in the training pipeline.
   c. With model operational referring to using the trained and deployed model in an operational mode.
   d. With data & model monitoring referring to validating that the inference data are from a distribution that aligns well with the training data, as well as monitoring model outputs for detecting any performance, or operational, drifts.
A drift detection stage that informs about any drifts in the model operations

There currently exist certain challenge(s). There can be cases where the ML model deployed at the UE does not generalize to some scenarios, thus, the ML model output (e.g., the estimated CQI values, predicted CSI in one or more sub-bands, predicted beam measurements in the time and/or spatial domain, the estimated UE location) are not correct and/or the error interval is higher than acceptable level(s) and/or the accuracy (or accuracy interval(s)) is not acceptable. As the network performs transmission/reception actions based on the ML-model output, incorrect model output(s) can result in wrong decisions being made at the network side, and thereby, affecting the wireless communication performance. For example, based on a wrong beam measurement prediction reported by the UE, the network may activate a Transmission Configuration Information (TCI) state (and/or trigger a beam switching) at the UE which does not correspond to a beam the UE is able to detect (or has poor coverage performance); the wrong decisions may lead to Beam Failure Detections (BFD) and/or Beam Failure Recovery (BFR) and/or poor throughput and/or too much signaling due to sub-sequence CSI measurement configuration(s)/activations.

The current Third Generation Partnership Program (3GPP) New Radio (NR) standard does not have a mechanism to let the network spot a ML model problem when the ML model is deployed at a UE and the life cycle management of this ML model is handled at least partially at the UE side.

### SUMMARY

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

A system of one or more devices operating in a cellular telecommunications network can be configured to perform particular operations or actions by virtue of having software, firmware, hardware, or a combination of them installed on the system that in operation causes or cause the system to perform the actions. One general aspect includes a method performed by a user equipment (UE) for reporting a performance of at least one machine-learning (ML) model to a network. The method also includes utilizing at least one ML model; generating one or more reports or reportable information of a performance of the at least one ML model. The method also includes reporting the one or more reports or reportable information to a network node. Other embodiments of this aspect include corresponding computer systems, apparatus, and computer programs recorded on one or more computer storage devices, each configured to perform the actions of the methods.

One general aspect includes a method performed by a network node for receiving one or more reports of a performance of at least one ML model applied by a UE. The method also includes receiving, from a UE, one or more reports of the performance of the at least one ML model. Other embodiments of this aspect include corresponding computer systems, apparatus, and computer programs recorded on one or more computer storage devices, each configured to perform the actions of the methods.

### BRIEF DESCRIPTION OF THE DRAWINGS

For a more complete understanding of the present disclosure, reference is now made to the following descriptions taken in conjunction with the accompanying drawings, in which:

FIG. 1 illustrates the concept of machine learning models;

FIG. 2 shows a flow-chart of a method embodiment under the present disclosure;

FIG. 3 shows a flow-chart of a method embodiment under the present disclosure;

FIGS. 4A, 4B, and 4C show flow-charts of method embodiments under the present disclosure;

FIG. 5 shows a flow-chart of a method embodiment under the present disclosure;

FIG. 6 shows a flow-chart of a method embodiment under the present disclosure;

FIG. 7 shows a flow-chart of a method embodiment under the present disclosure;

FIG. 8 shows a schematic of a communication system embodiment under the present disclosure;

FIG. 9 shows a schematic of a user equipment embodiment under the present disclosure;

FIG. 10 shows a schematic of a network node embodiment under the present disclosure;

FIG. 11 shows a schematic of a host embodiment under the present disclosure;

FIG. 12 shows a schematic of a virtualization environment embodiment under the present disclosure; and

FIG. 13 shows a schematic representation of an embodiment of communication amongst nodes, hosts, and user equipment under the present disclosure.

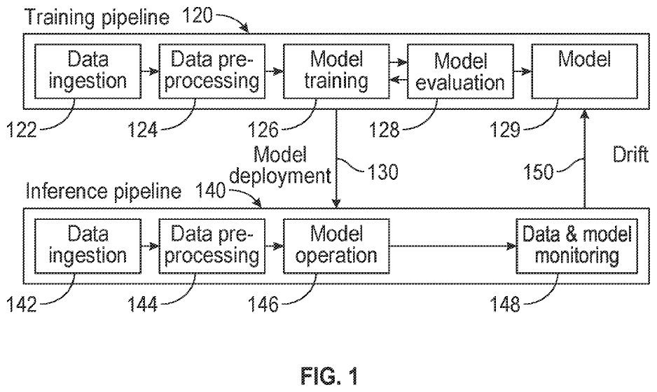

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

For purposes of the present disclosure, the terms “ML model” and “AI model” are interchangeable. An AI/ML model can be defined as a functionality, or be part of a functionality, that is deployed/implemented in a first node (e.g., a UE). The first node (e.g., the UE) can detect that the functionality is not performing correctly or is not acceptable: this may correspond to a prediction error not being acceptable (e.g., prediction error higher than a pre-defined value), error interval is not in acceptable levels, or prediction accuracy is lower than a pre-defined value. Further, an AI/ML model can be defined as a feature or part of a feature that is implemented/supported in a first node. This first node can indicate the feature version to a second node. If the ML model is updated, the feature version maybe changed by the first node.

Certain aspects of the disclosure and their embodiments may provide solutions to the identified challenges or other challenges. The present disclosure includes methods at a User Equipment (UE) and a Network node. For data communication, the network node may take many forms, including: gNodeB, gNodeB-Distributed Unit (gNB-DU), gNodeB-Central Unit (gNB-CU), relay node, a 6G Radio Access Node (RAN), core network node, or an Over the Top (OTT) server, or device supporting D2D communications. For the functionality of locating a UE's, the network node may be gNB, gNB-DU, gNB-CU, LMF (Location Management Function), or other types of Location Server (E-SMLC (Enhanced Serving Mobile Location Centre), SLP (SUPL Location Platform)).

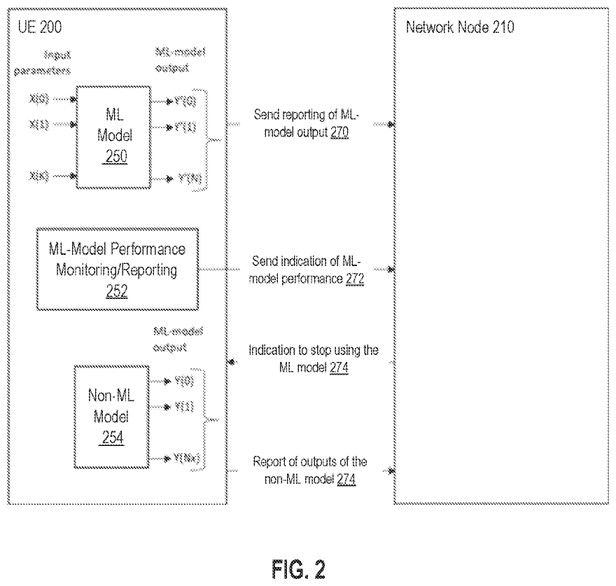

FIG. 2 shows a schematic diagram of how possible input parameters and ML model outputs interact or result from the ML model, and get fed to ML model performance monitoring, and how reporting between system components can be performed. An exemplary system includes a UE 200 in communication with a network node 210. The UE 200 supports and/or generates an ML model 250 receiving input parameters x(0), x(1) . . . x(K), and yielding outputs y′(0), y′(1) . . . y′(N). These outputs are received by the ML model performance monitoring and/or reporting function 252. Based on the monitoring, reports can be sent to the network node 210. Reporting of ML models can be periodic or aperiodic, as described in more detail below. Some embodiments, may include one or more non-ML models 254.

The component of FIG. 2 can perform respective functions to obtain benefits from ML-model performance. For example, the UE may transmit a report of the ML model 250's output to the network node 210 in an operation 270. The UE 200, alternatively or additionally, transmits or sends an indication of ML-model performance to the network node 210 in an operation 270. At an operation 274, the network node 210 may send (and the UE 200 may receive) an indication to stop using a currently used ML model. This indication to stop using the ML model may be a command in some embodiments or a recommendation in other embodiments. In some embodiments, the method may include a subsequent operation 276 in which the UE sends a report based on the non-ML model 254. The network node may respond with a confirmation to continue using the non-ML model 254 or to revert to the ML model 250 or another ML model that is different than the ML model 250.

Certain method embodiments of the present disclosure can be performed at a UE operating with at least one ML model (e.g., based on which the UE performs one or more predictions), including methods comprising the UE reporting one or more indication(s) of the performance of the at least one ML-model to the network (NW).

Certain method embodiments of the present disclosure can comprise the UE reporting the one or more indication(s) of the performance of the at least one ML-model based on one or more rules and/or triggers, e.g., detection of the ML-model performance problems and/or failure(s).

Certain method embodiments of the present disclosure can comprise the UE reporting the one or more indication(s) of the performance of the at least one ML-model based on one or more configurations from the network node (e.g., reporting configuration(s)).

Types of defined reports sent by the UE 200 to the network node 210 can include at least the following (e.g., possibly configured by the network):
Report type 1: Periodic report from the UE to the NW. Prior to the report, the NW can configure the UE to perform a report in a periodic manner, and the associated configuration of reporting resources such as physical channel (e.g., an Uplink channel, random access channel, PUCCH, PUSCH, PSSCH, PSFCH), frequency and/or time and/or coding resources.
Report type 2: Aperiodic report from UE configured/requested by the NW.
   Report type 2.1: The NW can request the UE to perform an aperiodic report. In this report type, the UE performs the aperiodic report without a dependence on the occurrence of a certain event or condition. The NW may or may not trigger the aperiodic report based on a detected sudden performance shift of the UE ML model.
   Report type 2.2: The NW configures the UE to perform an event/condition-based aperiodic report. In this report type, the UE only performs the aperiodic report if a certain event or condition occurs.
Report type 3: Aperiodic report from UE without NW configuration.
   Report type 3.1: Aperiodic event/condition-based report based on specification rules. In this report type, specification rules may trigger the UE to send an aperiodic report to the NW.
   Report type 3.2: Aperiodic event/condition-based report based on UE implementation rules. For instance, the UE may utilize specification signaling to indicate to the NW that the ML-model is not functioning within certain performance bounds.

Joint inference and reporting: The one or more indication(s) of the performance of the at least one ML-model can be transmitted in a report defined for that purpose (e.g., CSI ML-model performance report) and/or the one or more indication(s) of the performance of the at least one ML-model can be transmitted in association with the model output, e.g., ML-output and the one or more indication in the same report, and/or by specification text, where the rules of such association could be pre-specified in the specification text, e.g., each time inference is performed, or by regular intervals. This joint report may also be also configurable by the network.

The UE monitors the performance of the at least one ML-model (by performing an ML-model performance analysis) and reports the one or more ML-model performance indication(s) to the network node.

The ML-model performance report can include one or more indication(s) of at least one of the following parameters:
A value in percentage that indicates the confidence level of its ML-model output.
A confidence interval (where the confidence level can either be included or e.g., specified in specification text).
An uncertainty level of the ML model output. For example, the uncertainty of a timing value in positioning (e.g., time of arrival (TOA) of signal from a transmit point (TP) as estimated by the UE); the uncertainty of the coordinates (x, y, z) at the output of UE's ML model; the uncertainty of the estimated UE velocity at the output of UE's ML model. Depending on the type of uncertainty, the uncertainty may take different type of units (e.g., nanoseconds for estimated timing; meters/centi-meters for estimated spatial coordinates; m/s for estimated velocity, etc.). The granularity of the uncertainty can be specified as well (e.g., 10 nanoseconds; 10 centi-meters; 0.1 m/s, etc.).
The statistic info of the data collected within a time window (e.g., data collected in one second starting from the time when receiving the request for ML-model performance reporting).
Indication that model output should or should no longer be trusted/valid. (e.g., a single bit indication). Such signaling could also imply a switch to a non-ML algorithm by the UE and could be associated with the aforementioned metrics, e.g., that the signaling is triggered when exceeding a certain confidence level/interval. The definition of such metrics could be up to UE implementation, configured to the UE or provided by specification text.
Some form of identification on which ML-model or ML feature the ML-model performance report is associated to. This may be a direct link by some form of index or ID, or similar. It can also be based on which time/frequency or resource the report is sent on.
Indication that input data to the model is currently out-of-distribution (e.g., a single bit indication).
The ML-model performance indication may be reported for different granularities.
   For example, the ML-model performance indication may be reported per frequency range, as the ML-model may perform better or worse for FR1 than for FR2, in the case of beam measurement predictions so that upon reception the network may decide to configure the usage of the ML-model per frequency range.
   Other examples of different granularities for the performance report may correspond to per sub-band or sets of sub-bands, for different Bandwidth Parts (BWPs), for different cells (e.g., different serving cells, like SpCell and SCell(s)), for different RS beams (e.g., different SSB/CSI-RS/SRS beams), for different UE speeds, etc.
The ML model performance report can be sent together with the ML-model output.
   The report may be sent as an independent message, or the report may be sent as part of other messages, e.g., a CSI report.
   The inclusion of the ML model performance with the ML-model output may be indicated to the UE as enable in a CSI reporting configuration (e.g., in the IE CSI-ReportConfig).
The ML-model performance monitoring may be done by the UE for different functionalities and may trigger different actions depending on the functionality.

At the network side, e.g., the network node receiving the report of the one or more indications of the ML-model performance, and/or based on an analysis of the ML-model performance, may take some actions, such as:
(Stop using the ML-model): The network node can transmit to the UE (and the UE receives) an indication/configuration for the UE to stop using the ML-model (for which the one or more indication(s) of the ML-model performance has/have been reported), wherein stop using the ML-model comprises i) stop performing predictions/estimations based on the one or more ML-model(s) and/or stop producing outputs from the one or more ML-models(s) and/or stop reporting outputs from the one or more ML-models(s). The indication/configuration may be transmitted in an RRC message (e.g., RRC Reconfiguration), MAC CE or DCI, and based on the indication/configuration the UE perform the indicated/configured actions; and/or
(Start/re-start using the classical non-ML-algorithm/function): The network node can transmit to the UE (and the UE receives) an indication/configuration for the UE to start using a reporting mode (e.g., CSI report) not based on the one or more ML-model outputs (wherein the ML-model is the model for which the one or more indication(s) of the ML-model performance has/have been reported). The indication may be transmitted in an RRC message (e.g., RRC Reconfiguration), MAC CE or DCI, and based on the indication/configuration the UE perform the indicated/configured actions. The outputs of the ML-model e.g., Y′(0), . . . , Y′(N) there may be one or more parameters Y(0), . . . , Y(Nx) based on conventional non-ML model algorithm(s)/functions. For example, if the ML-model produces as output(s) one or more predictions/estimates of CSI for CSI reporting, the UE transmits the actual CSI (either instead or in addition to the estimates).
   NOTE: In this context, a classical non-ML algorithm/function may correspond to the UE performing one or more measurements instead of predictions, or the UE not performing predictions. A classical non-ML algorithm/function refers to the fact that the legacy UEs would operate according to these types of algorithms/functions, based on measurements instead of predictions. For example, if the UE was performing RSRP predictions for one or more SSBs, the UE start/restart using the classical non-ML algorithm/function comprises the UE stopping performing these RSRP predictions and performing actual RSRP measurements.
(Training/re-training of ML-model): The network node can transmit to the UE (and the UE receives) an indication/configuration for the UE to perform the training (and/or re-training and/or update) of the ML-model (for which the one or more indication(s) of the ML-model performance has/have been reported), wherein the indication/configuration may be transmitted in an RRC message (e.g., RRC Reconfiguration), MAC CE or DCI. In response to the re-training, the UE may continue performing the monitoring of the ML-model performance

Based on the ML-model performance report, the network node can decide how much it would rely on the inference outcome of the ML-model when making transmission/reception decisions.

The network node can also store the received ML-model performance report, detect a potential error(s) of in the ML-model, and then feed back such info to the UE to assist its ML-model error analysis or trigger its ML-model retraining and update

One aspect of embodiments under the present disclosure includes the UE reporting to the network one or more indications on the ML-model performance, comprising network signaling and UE reporting methods to enable a network to spot a ML-model performance problem at a UE. The other actions occur after the UE transmits the report, such as the reception of network indications/re-configurations e.g., indicating the UE stop using the ML-model and/or to start/re-start ML-model training.

Certain embodiments may provide one or more of the following technical advantage(s). The proposed solution can enable the UE to indicate to the network one or more indication of the ML-model performance and/or an ML model problem(s) when the ML model is deployed at the UE, wherein the UE is also capable of monitoring the performance of the ML-model. Thus, the network can take right actions when performing transmissions/receptions to/from this UE and/or assess whether and/or how the ML-model outputs may be used at the network side for decision making processes at least partially based on the ML-model outputs.

An ML model may correspond to a function which receives one or more inputs (e.g., measurements) and provide as outcome one or more prediction(s)/estimates of a certain type. In one example, an ML model may correspond to a function receiving as input the measurement of a reference signal at time instance t0 (e.g., transmitted in beam-X) and provide as outcome the prediction of the reference signal in time t0+T. In another example, an ML model may correspond to a function receiving as input the measurement of a reference signal X (e.g., transmitted in beam-x), such as an SSB whose index is ‘x’, and provide as outcome the prediction of other reference signals transmitted in different beams e.g., reference signal Y (e.g., transmitted in beam-x), such as an SSB whose index is ‘y’. Another example is an ML model for aid in CSI estimation, in such a setup the ML model can be a specific ML model with a UE and an ML model within the NW side. Jointly both ML models provide joint network. The function of the MLb model at the UE would be to compress a channel input and the function of the ML model at the NW side would be to decompress the received output from the UE. It is further possible to apply something similar for positioning wherein the input may be a channel impulse in some form related to a certain reference point (typically a TP (transmit point)) in time. The purpose on the NW side would be to detect different peaks within the impulse response, that reflects the multipath experienced by the radio signals arriving at the UE side. For positioning another way is to input multiple sets of measurements into an ML network and based on that derive an estimated position of the UE. Another ML-model would be an ML-model to be able to aid the UE in channel estimation or interference estimation for channel estimation. The channel estimation could for example be for the PDSCH and be associated with specific set of reference signals patterns that are transmitted from the NW to the UE. The ML-model can then be part of the receiver chain within the UE and may not be directly visible within the reference signal pattern as such that is configured/scheduled to be used between the NW and UE. Another example of an ML-model for CSI estimation is to predict a suitable CQI, PMI, RI, CRI (CSI-RS resource indicator) or similar value into the future. The future may be a certain number of slots after the UE has performed the last measurement or targeting a specific slot in time within the future.

The architecture of an ML model (e.g., structure, number of layers, nodes per layer, activation function etc.) may need to be tailored for each particular use case. For example, properties of the data (e.g., CSI-RS channel estimates), the channel size, uplink feedback rate, and hardware limitations of the encoder and decoder may all need to be considered when designing the ML model's architecture.

After the ML model's architecture is fixed, it needs to be trained on one or more datasets. To achieve good performance during live operation in a network (the so-called inference phase), the training datasets need to be representative of the actual data the ML model will encounter during live operation in the network.

The training process often involves numerically tuning the ML model's trainable parameters (e.g., the weights and biases of the underlying NN) to minimize a loss function on the training datasets. The loss function may be, for example, the Mean Squared Error (MSE) loss calculated as the average of the squared error between the UE's downlink channel estimate H and the network's reconstruction Ĥ, i.e., ∥H−Ĥ∥². The purpose of the loss function is to meaningfully quantify the reconstruction error for the particular use case at hand.

The training process is typically based on some variant of the gradient descent algorithm, which, at its core, comprises three components: a feedforward step, a back propagation step, and a parameter optimization step. We now review these steps using a dense ML model (i.e., a dense NN with a bottleneck layer) as an example.

Feedforward: A batch of training data, such as a mini-batch, (e.g., several downlink-channel estimates) is pushed through the ML model, from the input to the output. The loss function is used to compute the reconstruction loss for all training samples in the batch. The reconstruction loss may be an average reconstruction loss for all training samples in the batch.

The feedforward calculations of a dense ML model with N layers (n=1, 2, . . . , N) may be written as follows: The output vector a\hat{ }([n]) of layer n is computed from the output of the previous layer a^{[n-1]} using the equations:

$${z}^{[ n ]} = {W}^{[ n ]} \cdot {a}^{[ n - 1 ]} + {b}^{[ n ]} , {a}^{[ n ]} = g ( {z}^{[ n ]} )$$

In the above equation W^{[n]} and b^{[n]} are the trainable weights and biases of layer n, respectively, and g is an activation function applied elementwise (for example, a rectified linear unit).

Back propagation (BP): The gradients (partial derivatives of the loss function, L, with respect to each trainable parameter in the ML model) are computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n+1.

For a dense ML model with N layers the back propagation calculations for layer n may be expressed with the following equations

$$\frac{\partial L}{\partial {a}^{⌈ n ⌉}} = {[ {W}^{[ n + 1 ]} ]}^{T} \cdot \frac{\partial L}{\partial {z}^{⌈ n + 1 ⌉}} , \frac{\partial L}{\partial {z}^{⌈ n ⌉}} = \frac{\partial L}{\partial {a}^{⌈ n ⌉}} * {g}^{{[ n ]}^{′}} ( {z}^{[ n ]} ) ,$$

$$\frac{\partial L}{\partial {W}^{[ n ]}} = \frac{\partial L}{\partial {z}^{[ n ]}} \cdot {[ {a}^{[ n - 1 ]} ]}^{T} , \frac{\partial L}{\partial {b}^{[ n ]}} = \frac{\partial L}{\partial {z}^{[ n ]}} ,$$

Where * here denotes the Hadamard multiplication of two vectors.

Parameter optimization: The gradients computed in the back propagation step are used to update the ML model's trainable parameters. An approach is to use the gradient descent method with a learning rate hyperparameter (α) that scales the gradients of the weights and biases, as illustrated by the following update equations

$${W}^{[ n ]} = {W}^{[ n ]} - α \cdot \frac{\partial L}{\partial {W}^{[ n ]}} , {b}^{[ n ]} = {b}^{[ n ]} - α \cdot \frac{\partial L}{\partial {b}^{[ n ]}} .$$

A core idea here is to make small adjustments to each parameter with the aim of reducing the average loss over the (mini) batch. It is common to use special optimizers to update the ML model's trainable parameters using gradient information. The following optimizers are widely used to reduce training time and improving overall performance: adaptive sub-gradient methods (AdaGrad), RMSProp, and adaptive moment estimation (ADAM).

The above process (feedforward, back propagation, parameter optimization) is repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined user data throughput gain with respect to a baseline CSI reporting method (e.g., a MIMO precoding method is selected, and user throughputs are separately estimated for the baseline and the ML model CSI reporting methods). The above actions use numerical methods (e.g., gradient descent) to optimize the ML model's trainable parameters (e.g., weights and biases). The training process, however, typically involves optimizing many other parameters (e.g., higher-level hyperparameters that define the model or the training process). Some example hyperparameters are as follows:
The architecture of the ML model (e.g., dense, convolutional, transformer);
Architecture-specific parameters (e.g., the number of nodes per layer in a dense network, or the kernel sizes of a convolutional network);
The depth or size of the ML model (e.g., number of layers);
The activation functions used at each node within the ML model;
The mini-batch size (e.g., the number of channel samples fed into each iteration of the above training steps);
The learning rate for gradient descent and/or the optimizer; and
The regularization method (e.g., weight regularization or dropout).

Additional validation datasets may be used to tune the ML model's architecture and other hyperparameters.

The present disclosure includes embodiments of a network signaling and UE reporting method to assist a network node to identify a ML-model problem at a UE, where the ML-model is at least in part at the UE and the life cycle management of this ML model is handled at least in part at the UE side. The network, NW, in the present disclosure can be one of a generic NW node, gNB, base station, unit within the base station to handle at least some ML operation, relay node, core network node, a core network node that handle at least some ML operations, a device supporting D2D communication, a LMF or other types of location server.

At least the following types of reports may be configured:
Report type 1: Periodic report from the UE to the NW. Prior to the report, the NW configures the UE to perform a report in a periodic manner.
Report type 2: Aperiodic report from UE configured/requested by the NW.
   Report type 2.1: The NW requests the UE to perform an aperiodic report. In this report type, the UE performs the aperiodic report without a dependence on the occurrence of a certain event or condition. Prior to the NW requesting an aperiodic report, the NW may have configured the UE with aspects related to the aperiodic report. The NW may or may not trigger the aperiodic report based on a detected sudden performance shift of the UE ML model.
   Report type 2.2: The NW configures the UE to perform an event/condition-based aperiodic report. In this report type, the UE only performs the aperiodic report if a certain event or condition occurs
Report type 3: Aperiodic report from UE without NW configuration.
   Report type 3.1: Aperiodic event/condition-based report based on specification rules. In this report type, specification rules may trigger the UE send an aperiodic report to the NW.
   Report type 3.2: Aperiodic event/condition-based report based on UE implementation rules. For instance, the UE may utilize specification signaling to indicate to the NW that the ML-model is not functioning within certain performance bounds

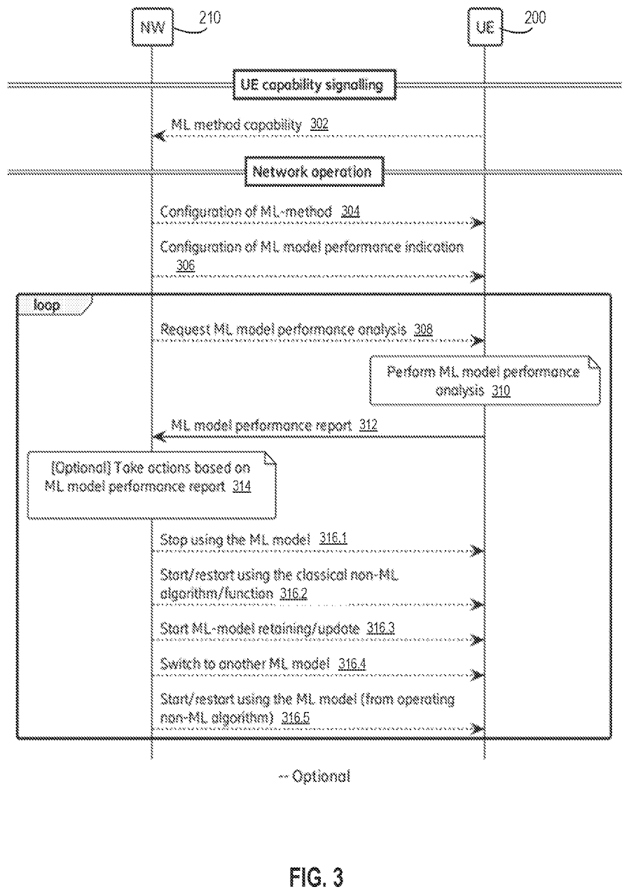

FIG. 3 is a flowchart of one proposed method 500 comprises at least the following operations:
Operation 302 [optional]: UE indicates capability of ML method (including ML model performance analysis) e.g., this capability may indicate which reporting method for the ML model performance reporting the UE supports.
Operation 304 [optional]: The ML model in the UE is configured by the network in certain aspects, e.g., model architecture, hyperparameters. loss function, or reward, alternatively such configuration is pre-defined, or applied with default settings. A hyperparameter is a parameter whose value is used to control the learning process in machine learning applications. Other parameters are derived via training.
Operation 306 [optional]: A UE operates with an ML model deployed at the UE.
Operation 308 [optional]: A UE operating with a ML model deployed at the UE is requested by a network node to provide one or more ML model performance indication(s).
Operation 310: The UE performs ML-model performance analysis/monitoring.
Operation 312: The UE reports the one or more ML-model performance indication(s) to the network node

Based on the reception of the one of more indication of the ML-model performance and/or the ML-model performance analysis/monitoring (e.g., the detection of an ML-model performance failure), the network (and UE) take or performs an action. For example, the network node 210 and our UE 200 further perform the following steps:
Operation 314: The network node may decide how much it relies on the inference outcome of the ML-model (e.g., the ML-outputs possibly reported by the UE) when making transmission/reception decisions.
Operation 316: The network node signals to the UE one or more indications/configurations received by the UE, to
   Stop using the ML-model (operation 316.1);
      In this case, the UE receives an indication/configuration for the UE to stop using the ML-model (for which the one or more indication(s) of the ML-model performance has/have been reported), wherein stop using the ML-model comprises i) stop performing predictions based on the one or more ML-model(s) and/or stop producing outputs from the one or more ML-models(s) and/or stop reporting outputs from the one or more ML-models(s). The indication/configuration may be transmitted in an RRC message (e.g., RRC Reconfiguration), MAC CE or DCI, and based on the indication/configuration the UE perform the indicated/configured actions; and/or
   Start/re-start using the classical non-ML-algorithm/function (operation 316.2);
      In this case, the UE receives an indication/configuration for the UE to start using a reporting mode (e.g., CSI report) not based on the one or more ML-model outputs (wherein the ML-model is the model for which the one or more indication(s) of the ML-model performance has/have been reported). The indication may be transmitted in an RRC message (e.g., RRC Reconfiguration), MAC CE or DCI, and based on the indication/configuration the UE perform the indicated/configured actions. The outputs of the ML-model e.g., Y′(0), . . . , Y′(N) there may be one or more parameters Y(0), . . . , Y(Nx) based on conventional non-ML model algorithm(s)/functions. For example, if the ML-model produces as output(s) one or more predictions/estimates of CSI for CSI reporting, the UE transmits the actual CSI (either instead or in addition to the estimates), as shown in FIG. 2.
   Start ML-model retaining/update (operation 316.3);
      In this case, the UE receives an indication/configuration to perform the training (and/or re-training and/or update) of the ML-model (for which the one or more indication(s) of the ML-model performance has/have been reported), wherein the indication/configuration may be transmitted in an RRC message (e.g., RRC Reconfiguration), MAC CE or DCI. In response to the re-training, the UE may continue performing the monitoring of the ML-model performance.
   Switch to another ML model (operation 316.4);
      In this case, the UE receives an indication/configuration to switch to start using another ML-model (possibly known by the network to have an acceptable ML-model performance), wherein the indication/configuration may be transmitted in an RRC message (e.g., RRC Reconfiguration), MAC CE or DCI
      In an example, this another ML model can have a different optimization objective (e.g., loss function or reward) compared to the ML model used at the UE. For example, for the CSI feedback, UE uses the ML model that performs CSI compression to reduce the feedback overhead, in this step, the network may indicate the UE to switch to another ML model for CSI feedback, where this ML model optimizes the CSI reconstruction accuracy with a fixed feedback overhead constraint. In another example, this another ML model can have a different ML-architecture compared to the ML model used at the UE.
   Switch/restart using the ML model (from operating non-ML algorithm (operation 316.5)
      In an example, the UE switches to the ML model after operating the non-ML algorithm for a period of time.

The different UE actions (possibly configured by the network) may be associated to one or more UE capabilities known to the network e.g., because the UE previously reported them.

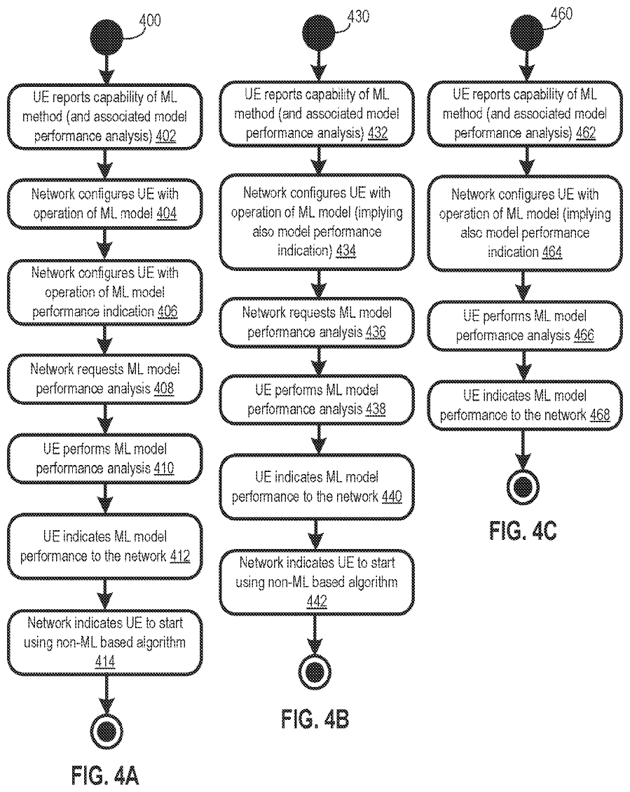

FIG. 3 shows the overview of the proposed signaling between NW and UE. A few of the different embodiments of the optional operations in the above description are illustrated in flowcharts shown in FIGS. 4A, 4B, and 4C. Other possibilities can also be extracted from the signaling diagram in FIG. 3.

FIG. 4A shows a method 400, in which: the UE reports inability of ML method and associated model performance analysis (at operation 402); the network (e.g., a network node of the network) configures the UE with an operation of the ML model (at operation 404); the network configures the UE with an ML model performance indication (at operation 406); the network requests ML model performance analysis by the UE (at operation 408); the UE performs the requested ML model performance analysis (at operation 410); the UE indicates (transmits and indicator or indication) of the ML model performance to the network (at operation 412); and the network indicates to the UE to begin using a non-ML based algorithm (at operation 414) when the network determines performance is likely to be improved by the change.

FIG. 4B shows a method 430, in which: the UE reports capability of the ML method and associated model performance analysis (at operation 432); the network configures the UE with or for operation of a selected ML model and, by implication, model performance analysis (at operation 434); the network requests the UE perform ML model performance analysis (at operation 436); the UE performs the ML model performance analysis (at operation 438); the UE indicates ML model performance to the network, e.g., by transmitting a performance report to the network (at operation 440); and the network indicates to the UE to start using a non-ML based algorithm (at operation 442) when the network determines a performance can be improved thereby.

FIG. 4C shows a method 460, in which: the UE reports capability of the ML method and associated model performance analysis (at operation 462); the network configures the UE with or for operation of a selected ML model and, by implication, model performance analysis (at operation 464); the UE performs ML model performance analysis without a network request (at operation 466); and the UE indicates ML model performance to the network, e.g., by transmitting a performance report or report indicator to the network (at operation 468).

### Different Reporting Nodes

Different reporting modes are foreseen for ML-model performance report. These include periodic and aperiodic reporting modes. They may either be configured separately (e.g., in different messages, not at the same time at the UE), or these may be simultaneously configured at the UE. Further the reports that are not configured but given by the specification and be operated simultaneously by the UE. Simultaneously does not necessarily mean that they are reported at the same time interval or overlapping time interval. Rather that they can be reported for example to the same network node either at the same time or after each other with some time interval in between. The UE may report different capabilities for each of these different reporting modes, or a capability associated to all the reporting modes

Note: In general terms, for the different types of report defined as follows, the UE preferably obtains one or more configuration(s) about the report of the ML model performance, which may either be from a message received from the NW, or from the UE memory (e.g., in case the UE is hard coded with information on how to report the ML-model performance) or a combination of both. Hence, when the embodiments and options disclose the configuration(s) it should be interpreted as either received from the NW via a message or retrieved from the UE memory.

Report Type 1: Periodic Report from the UE to the NW.

In one embodiment, the UE performs periodic reporting of its ML model performance. In another embodiment, the UE is configured by the network node to do periodic reporting of its ML model performance.

Periodic reporting of ML model performance is advantageous, for example, when the ML-model at the UE is used for non-time-critical services and it is running in a relatively stable environments, where channel statistics, traffic distributions, or/and UE movements don't change rapidly. Thereby, the input data distributions as well as the mapping between the input data and output data of the ML-model holds for a relative long period, e.g., in a few days. In the case the ML model performance is for an ML model associated to one or more information defined in a CSI report (UCI, beam reporting, RSRP/SINR of SSB resource and/or CSI-RS resource), it may also be advantageous to transmit a periodic report of the ML performance if the CSI report is also periodic.

The configuration of the periodic report of the ML-model performance may be received in (or obtained) an RRC message received by the UE in a signaling radio bearer, e.g., SRB1, configured at the UE, or/and in a specific RRC signaling and/or in an Information Element (IE) defined in RRC. Upon reception of the configuration, the UE performs ML-model performance monitoring and determines what information about the ML-model performance to include in the report, on which radio resources to send this periodic report (time slots and/or frames and/or subframes the allowed to be used for the transmissions, e.g., in case of PUCCH, frequency domain resources, exact control channel in the UL to be used), or whether the UE shall send a scheduling request for requesting UL resources to transmit the report

The configuration received from the NW and/or obtained at the UE memory would preferably further indicate at least one of the following:
The ML model(s) and/or ML features to periodically report the performance for. Note that a single ML-model performance report may include performance information about one or more ML-models, wherein these may be possibly associated to one or more functionalities or, for the same functionalities, associated to one or more granularities (e.g., different values for different sub-bands, bandwidth parts, etc.).
The validity of length of the report, i.e., how long the UE will report the performance. This configuration parameter may adopt the value infinity and hence be reported until some other condition makes the reporting stop. The reporting may also be actively stopped by NW reconfiguration to the UE.
If the performance monitoring is performed across multiple serving cells or only within the current serving cell, wherein this may be modeled by including the configuration in each serving cell configuration (e.g., in the IE ServingCellConfig, in a series of nested IEs). Alternatively, within a certain paging area or across different paging areas.
The content of ML-model performance report, see On the Content of the ML-model Performance Report, below.
Time window for the ML-model performance monitoring, i.e., if the report includes the current ML-model performance or the ML-model performance for a past period of time. This may be necessary in case the UE needs a number of measurements and/or samples to derive the one or more indications of the ML-model performance.
If the monitoring is to be stopped or suspended by the UE when the UE transitions to RRC IDLE and/or RRC INACTIVE STATE from RRC_CONNECTED STATE, or if the monitoring is to be maintained by the UE (e.g., for later reporting when the UE transitions to RRC_CONNECTED).
If the ML-model performance monitoring is performed both in DRX and non-DRX operation by the UE. It could be so that the performance of the ML-model is only monitored in non-DRX when the report is possible to be sent by the UE.
If the monitoring of the ML-model performance is stopped when UL timing alignment is lost. That is when the UE has lost UL synchronization. That could for example be determined by the expiry of the timeAlignmentTimer. Alternatively, the performance monitoring may continue if an event is triggered. In such cases, the UE can try to achieve UL synchronization and, subsequently, transmit the associated report.
Information on which resources in time, frequency, and code domain the periodic ML-model performance report is sent. For example, this information may specify the resource blocks, slot/subframe, the symbols in time, and/or the type of code (e.g., spreading code or orthogonal code) where the performance report is sent.
Information for which time instance or instances the periodic ML-model performance report should represent the performance. A time instance or instances may represent one of the following slot(s), symbol(s), subframe(s) or SFN(s). If multiple instances are included multiple ML-model performance reports may could be include in the reported. For example, multiple entries of what is given in On the Content of the ML-model Performance Report, below. It is also possible that the reported value is average, mean, median, max or min.
Information about the periodicity and time domain offset (e.g., time slot) based on which the UE derives which time domain resources are allowed to be used for transmitting the report e.g., IE CSI-ReportPeriodicityAndOffset.
Information about one or more PUCCH resources to use for reporting on PUCCH e.g., indicated by a SEQUENCE (SIZE (1 . . . maxNrofBWPs)) OF PUCCH-CSI-Resource.
The reporting quantity for the ML-model performance monitoring in case there may be multiple performance metrics the UE is capable of measuring (there may be different UE capabilities reported to the network, based on what the UE is capable of measuring in terms of metric for ML-model performance monitoring).

In a set of embodiments, the configuration of the periodic ML-model performance is done by both RRC, MAC CE or L1 signaling. The configuration as such is setup by RRC signaling but can be activated/deactivated by either a later second RRC message, MAC Control Element (CE) or L1 signaling from the NW to the UE. The L1 signaling can for example be a Downlink Control Information (DCI) format. After the UE receives such a message, the UE can start the periodic ML-model performance monitoring and reporting according to the configuration. The UE may further stop the reporting after receiving a third message by RRC, MAC CE or L1 indicating that the reporting should stop.

In one embodiment, if the UE is not provided with UL resources for transmission of the periodic report the UE transmits a scheduling request for UL resources, to then transmit the report e.g., over PUSCH.

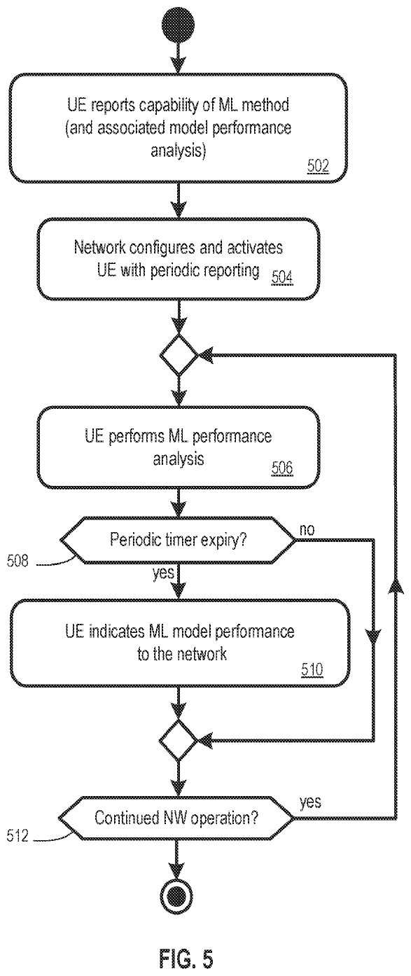

One of the embodiments of reporting type 1 is shown in FIG. 5, which is a flowchart of a method of generating/receive ML model performance. The method 500 of FIG. 5 may begin at an operation 502, in which the UE reports its capability with respect to ML methods it can utilize and associated model performance analysis it can perform. At operation 504 the network (via a network node) configures and activates the UE to periodically report on the performance of the utilized ML model. At operation 506, the UE performs the ML performance analysis. At operation 508, the UE determines that a periodic timer for ML performance reporting has expired. When the UE determines that the periodic timer has expired, the UE provides an indication of the ML model performance to the network, at operation 510. The network may thereafter determine whether to continue operations or make changes, at operation 512.

### Report Type 2.1: The NW Requests the UE to Perform an Aperiodic Report.

In one embodiment, the UE performs aperiodic reporting of the ML model performance. In another embodiment, the UE is requested by the network node to perform an aperiodic reporting of its ML model performance (e.g., without a dependence on the occurrence of a certain event or condition). Based on receiving the request for an aperiodic ML-model performance reporting in the UE (e.g., a DCI and/or MAC CE received after the UE has been configured with the configuration for the aperiodic report of ML-model performance monitoring), the UE generates the report accordingly and further sends the corresponding report to the NW.

Prior to the UE being requested by the NW to send an aperiodic ML-model performance report, the NW may have configured the UE with one or more configurations related to the aperiodic ML-model performance report. The one or more configurations related to the aperiodic ML-model performance report may be received by the UE in (or obtained) an RRC message received by the UE in a signaling radio bearer, e.g., SRB1, configured at the UE and/or in an Information Element (IE) defined in RRC. Upon reception of the configuration, the UE performs ML-model performance monitoring in case it is at a later point requested by the network to report the ML-model performance monitoring; and/or the UE starts performing the ML-model performance monitoring according to the configuration received if it later receives another indication (e.g., DCI) that it needs to perform the ML-model performance monitoring and report it.

The configuration of the aperiodic report may include at least one of the following:
The ML model(s) and/or ML features to report the performance for. Note that a single ML-model performance report may include performance information about one or more ML-models, wherein these may be possibly associated to one or more functionalities or, for the same functionalities, associated to one or more granularities (e.g., different values for different sub-bands, bandwidth parts, etc.).
Time window for the performance monitoring, i.e., if the report includes the current ML-model performance or the ML-model performance at a past occasion in time. If the ML-model performance is for a past occasion in time, the configuration may also include information about how long backwards in time it is possible for the NW to request an aperiodic ML-model performance report.
The number of reporting occasions. The default may be a single occasion.
The content of ML-model performance report, see On the Content of the ML-model Performance Report, below.
The aperiodic ML-model performance report may be configured with an ID that is used later by the NW to request the report by pointing to the specific ID.
Information about one or more PUCCH resources to use for reporting on PUCCH e.g., indicated by a SEQUENCE (SIZE (1 . . . maxNrofBWPs)) OF PUCCH-CSI-Resource.
Information about one or more PUSCH resources to use for reporting on PUSCH.
The reporting quantity for the ML-model performance monitoring, in case there may be multiple performance metrics the UE is capable of measuring (there may be different UE capabilities reported to the network, based on what the UE is capable of measuring in terms of metric for ML-model performance monitoring

The NW triggers/request an aperiodic ML-performance report by the UE with an RRC message, MAC CE or L1 signalling. The L1 signalling can for example be a Downlink Control Information (DCI) format. If the request/trigger of the aperiodic ML-performance report is performed via an RRC message, the configuration of the aperiodic ML-model performance report may be directly included in the trigger/request message from the NW.

The NW trigger/request message (e.g., MAC CE, RRC or L1 signaling) preferably includes at least one indication or reference of one or more of the following:
Which ML model(s) and/or ML features to report the performance for
Aperiodic ML-model report ID, according to the above RRC configuration message, indicating what is to be monitored and/or reported in terms of ML-model performance monitoring.
Information on which resources in time, frequency, and code domain the periodic ML-model performance report is sent. For example, this information may specify the resource blocks, slot/subframe, the symbols in time, and/or the type of code (e.g., spreading code or orthogonal code) where the performance report is sent.
Information for which time instance or instances the aperiodic ML-model performance report should represent the performance. A time instance or instances may represent one of the following slot(s), symbol(s), subframe(s) or SFN(s). If multiple instances are included multiple ML-model performance reports may could be include in the reported. For example, multiple entries of what is given in On the Content of the ML-model Performance Report, below. It is also possible that the reported value is average, mean, median, max or min.
Further, it may also include some or all of the information(s) that was outline for the RRC message that configures the aperiodic ML-model report.

In one embodiment, if the UE is not provided with UL resources for transmission of the periodic report the UE transmits a scheduling request for UL resources, to then transmit the report e.g., over PUSCH, upon reception of the NW trigger/request message.

For instance, the NW may request the report due to a) for the purposes of acquiring information on the ML-model(s) performance without observing any direct performance drop by the UE or other UEs, or b) the NW observing performance drops in the ML-model(s) by the UE or other UE/s. In the latter case b), the network may request the report after evaluating that ML-model performance is worse than an acceptable performance (e.g., defined by a threshold) and/or it changes quickly within a time window. The ML-model performance evaluation carried out by the network may be based on, e.g.,
the communication performance. The network node may indicate the UE to perform aperiodic reporting based on, e.g., a degradation of the downlink or uplink throughput within a given time window.
the information obtained through the periodic ML-model reporting, which can be configured at the same time for the UE. In this case, the network node may indicate the UE to perform aperiodic reporting based on, e.g., a value in percentage that indicates the confidence level of its ML-model output, a single bit indicating trust or no trust in the model, a single bit indicating that the input data is out-of-distribution, or a metric specific to the current model that ML performance is monitored for.

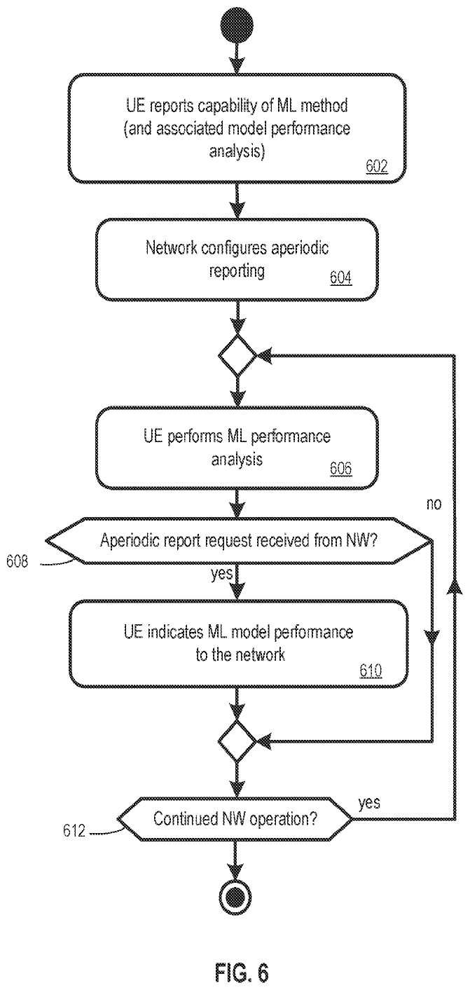

One of the embodiments of reporting type 2.1 is shown in FIG. 6, which is a flowchart of a method of generating/receive ML model performance. The method 600 of FIG. 6 may begin at an operation 602, in which the UE reports its capability with respect to ML methods it can utilize and associated model performance analysis it can perform. At operation 604 the network (via a network node) configures and activates the UE to aperiodically report on the performance of the utilized ML model. At operation 606, the UE performs the ML performance analysis. At operation 608, the UE determines whether a request from the NW for an ML model performance analysis has been received. When the UE determines that the request has been received, the UE provides an indication of the ML model performance to the network, at operation 610. The network may thereafter determine whether to continue operations or make changes, at operation 612.

### Report Type 2.2: The NW Configures the UE to Perform an Event/Condition-Based Aperiodic Report.

In one set of embodiments, the UE triggers a report if a certain event occurs and/or condition is satisfied. In another embodiment, the UE may be configured by the NW to trigger a report if a certain event occurs and/or condition is satisfied.

The event/condition may be one or more of the following:
The UE identifying that one or more of the metrics related to the ML-model are worse than an acceptable performance e.g., below/above a threshold.
   The threshold could be either configured by the NW, defined by the UE, or provided by specification text.
A fast change/relative change in ML-model performance, even if the absolute performance is above the threshold that characterizes an acceptable performance.
ML-model absolute or relative change in performance with respect to a reference model. The reference model may for example be another ML-model.
The UE identifying that one or more of the metrics related to the ML-model are better than an acceptable performance. The UE reports that when the ML-model improves its performance.
The UE detecting a failure of the ML-model based on the performance monitoring of one or more performance metrics of the ML-model. Further examples, concerning how a failure may be detected are provided in the sub-section entitled “Detection of a ML-model failure”, in the following.

The NW may configure the UE with configuration(s) related to the event/condition-based aperiodic ML-model performance report (e.g., upon reception of an RRC message) and/or the UE obtains them at the UE memory. The configuration may include one of the following:
The ML model(s) and/or ML features to report the performance for. Note that a single ML-model performance report may include performance information about multiple ML-models.
Conditions for event triggering, e.g., the metric used to measure the performance of the ML-models, and/or the metric performance threshold.
   Specific values of the threshold may be, e.g., specified in percentage, dB, or absolute value of a metric.
      For example, the percentage may define the confidence level of the ML-model output
   Specific values of the amount of relative change, e.g., in percentage, dB, or absolute value of a metric
      For example, the percentage, dB, or absolute value may define the confidence level of the ML-model output
If a reference model should be used to compare performance of the ML-model under evaluation, the identifier of such reference model. Such reference model may be a ML or a non-ML model.
The number of reporting occasions. The default may be a single occasion.
The content of ML-model performance report, see On the Content of the ML-model Performance Report, below.
The validity of length of the report, i.e., how long the UE will report the performance. This configuration parameter may adopt the value infinity and hence be reported until some other condition makes the reporting stop. The reporting may also be actively stopped by NW reconfiguration to the UE.
If the performance monitoring is performed across multiple serving cells or only within the current serving cell. Alternatively, within a certain paging area or across different paging areas.
If the monitoring is to be stopped or suspended by the UE when the UE transitions to RRC IDLE and/or RRC INACTIVE STATE from RRC_CONNECTED STATE
or if the monitoring is to be maintained by the UE (e.g., for later reporting when the UE transitions to RRC_CONNECTED)
If the ML-model performance monitoring is performed both in DRX and non-DRX operation by the UE. It could be so that the performance of the ML-model is only monitored in non-DRX when the report is possible to be sent by the UE.
If the monitoring of the ML-model performance is stopped when UL timing alignment is lost. That is when the UE has lost UL synchronization. That could for example be determined by the expiry of the timeAlignmentTimer. Alternatively, the performance monitoring may continue if an event is triggered. In such cases, the UE can try to achieve UL synchronization and, subsequently, transmit the associated report.
Information on which resources in time, frequency, and code domain the periodic ML-model performance report is sent. For example, this information may specify the resource blocks, slot/subframe, the symbols in time, and/or the type of code (e.g., spreading code or orthogonal code) where the performance report is sent.
Information for which time instance or instances the periodic ML-model performance report should represent the performance. A time instance or instances may represent one of the following slot(s), symbol(s), subframe(s) or SFN(s). If multiple instances are included multiple ML-model performance reports may could be include in the reported. For example, multiple entries of what is given in On the Content of the ML-model Performance Report, below. It is also possible that the reported value is average, mean, median, max or min.

The UE can monitor the performance of the ML-model according to the configured properties and, if the event is triggered, the UE can generate and send ML-model performance report to the NW. If the UE is in RRC_IDLE, RRC_INACTIVE STATE, the UE may go to RRC_CONNECTED STATE to send the report. Alternatively, the UE may wait until it goes to RRC_CONNECTED STATE for another reason, and subsequently send the report.

Upon reception of such report, the network node may activate other types of reporting, e.g., periodic or aperiodic network triggering reporting (see Report types 1 and 2.1 above).

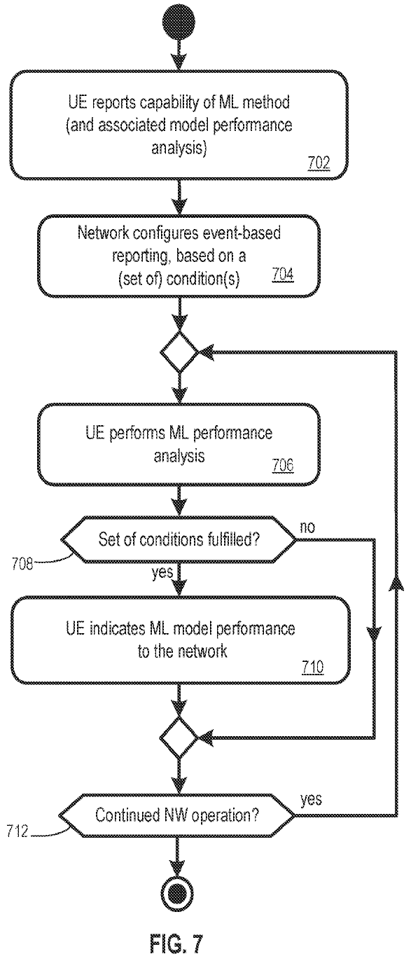

One of the embodiments of reporting type 2.1 is shown in FIG. 7, which is a flowchart of a method of generating/receive ML model performance. The method 700 of FIG. 7 may begin at an operation 702, in which the UE reports its capability with respect to ML methods it can utilize and associated model performance analysis it can perform. At operation 704 the network (via a network node) configures and activates the UE to report on the performance of the utilized ML model upon the detection or occurrence of one or more events or conditions. At operation 706, the UE performs the ML performance analysis. At operation 708, the UE determines whether the event(s) or condition(s) from the network node for an ML model performance analysis has occurred or been detected. When the UE determines the event or condition has occurred, the UE provides an indication of the ML model performance to the network, at operation 710. The network may thereafter determine whether to continue operations or make changes, at operation 712.

### Detection of a ML-Model Failure/Performance Problem

In one set of embodiments, the UE is configured by the network with an indication of an acceptable performance level for the ML-model (e.g., confidence interval within X and Y), based on which the UE monitors the performance of the ML-model. If upon monitoring the performance of the ML-model the confidence does not fall within the interval, the UE detects a problem in the ML-model and triggers the report of the ML-model performance to the network.

In another example, the ML model performance (satisfactory or not) is determined by observing the radio link performance after the ML output has been applied. For example, after UE recommends a beam or CQI according to the ML output, and the beam or CQI is used in subsequent data communication, then the UE can measure the link quality (e.g., SINR, RSRP, RSRQ). If the observed link quality is above a threshold, then the UE records it as a success of the ML model; otherwise, the UE records it as a failure of the ML model.

In another example, the ML model performance (satisfactory or not) is determined by comparing the ML output with a ground truth, or an expected output. For example, if the UE location is also estimated by means other than cellular radio signal (e.g., GNSS, WiFi, Bluetooth), then the GNSS-estimated (or WiFi or Bluetooth estimated) UE location (x0, y0, z0) can be used to determine if the ML model using cellular radio signal performs satisfactorily. For example, if the ML model using cellular radio signal as input produces output of (x1, y1, z1) as estimated UE location, and the distance between coordinate (x1, y1, z1) and coordinate (x0, y0, z0) is larger than a threshold (e.g., 5 meter), then this ML interference is recorded as a failure of the ML model. In one option, the UE is also configured with a COUNTER value so that the UE performs the report of the one or more indications of the ML-model performance as described above if a number of failure or problem instances in the ML-model reaches the COUNTER value. This COUNTER value could represent the maximum amount of failure which are tolerated.

In one option, the UE is configured with a TIMER value, wherein the failure or problem of the ML-model is considered to be detected only if the failure occurs for that time value. This means that the UE does not perform the reporting of the one or more indications of the ML-model performance if a failure or problem in the ML-model occurs in sparse time instances i.e. these would need to occur within a relatively short time.

In another option, the UE receives a TIMER value and a COUNTER value. When the UE receives an indication (internally at the UE) of a failure instance of an ML-model, the UE starts the TIMER and increments the COUNTER. If number of instances reaches the COUNTER value while the timer is running, the UE declares a failure in the ML-model and performs the reporting of the one or more indications of the ML-model performance. If the TIMER expires before the number of instances reaches the COUNTER value, the UE resets the COUNTER.

In one option the COUNTER and/or TIMER value(s) are part of the failure detection configuration the UE receives from the network.
In one option the performance monitoring of the ML-model is performed at the lower layers e.g., at the Layer 1 (L1) of the UE, and the monitoring of the COUNTER and TIMER is performed at the higher layers e.g., MAC layer or RRC layer.
In one option, the UE is also configured with a second COUNTER value which is incremented if an improvement is detected in the ML-model, wherein an improvement is detected if the ML-model performs equal or better than an acceptable performance level (e.g., confidence interval within X and Y).
In another option, the UE receives a TIMER value, a first COUNTER value and the second COUNTER value. When the UE receives an indication (internally at the UE) of failure instances of an ML-model, the UE increments the COUNTER and when than value reaches its COUNTER value (configured by the network, as a maximum value) the UE starts the TIMER. If the UE detects an improvement is detected in the ML-model, the second COUNTER is incremented, and if the second COUNTER reaches its maximum value the UE considers the ML-model as recovered, and would not perform ML-model performance reporting.
Another option is that when the TIMER starts the UE triggers the ML-model, so that re-training may improve the model while the TIMER is running, and there is a chance of recovery before the UE triggers the reporting of the ML-model performance.

In one set of embodiments, when the UE detects the ML-model failure/performance problem associated to a cell group (or a cell of the cell group, such as the SpCell) such as a Master Cell Group (MCG), e.g., as defined in TS 38.331, and the UE is in Multi-Radio Dual Connectivity (MR-DC), the UE transmits the report (including the one or more indications of the ML-model performance, such as an indication of an ML-model failure/performance problem) via a different cell group, such as a Secondary Cell Group (SCG).
In one embodiment, the report is included in an SCG Failure message transmitted to a network node operating as Master Node (MN). The MN receives the message including the report and sends to a network node operating as Secondary Node (SN). The SN, upon reception, may perform one or more of the actions as described in Step 6a and/or Step 6b.

In one set of embodiments, when the UE detects the ML-model failure/performance problem associated to a cell group (or a cell of the cell group, such as the SpCell) such as a Secondary Cell Group (SCG), e.g., as defined in TS 38.331, and the UE is in Multi-Radio Dual Connectivity (MR-DC), the UE transmits the report (including the one or more indications of the ML-model performance, such as an indication of an ML-model failure/performance problem) via a different cell group, such as the MCG, if an MCG reporting is configured.
In one embodiment, the report is included in an MCG Failure message transmitted to a network node operating as SN. The SN receives the message including the report and sends to the network node operating as MN. The MN, upon reception, may perform one or more of the actions as described in Step 6a and/or Step 6b.

### Report Type 3.1: Aperiodic Event/Condition-Based Report Based on Specification Rules.

In certain embodiments, instead of the NW defining the events that trigger ML-model performance report as in Report type 2.2, the events may be obtained from the UE memory (e.g., these could have also been defined in the 3GPP specification as UE actions which may not require an explicit configuration from the network).

The UE may obtain (e.g., from its memory) events such as those described in Report type 2.2. The specification may also define the aspects related to the ML-model performance to report, which may include those described in Report type 2.2. In addition, the specification may indicate if the UE may perform the reporting depending on whether the ML-model is configured for use. An illustrative example is that of an ML-model for CSI feedback, which is first executed by the UE when generating ML-based CSI reports

### Report Type 3.2: Aperiodic Event/Condition-Based Report Based on UE Implementation Rules.

In an embodiment, the UE implementation may define the events that trigger the ML-model performance report. For instance, the UE may utilize specification signaling to indicate to the NW that the ML-model is not functioning within certain performance bounds. The UE may utilize events such as those described in Report type 2.2.

### On the Messages Carrying the Report and Configuration(s)

In one set of embodiments, the UE receives the configuration for the ML-model performance monitoring in one or more of the following RRC messages in these different scenarios: i) an RRC Reconfiguration message, received by the UE during the transition from RRC_IDLE to RRC_CONNECTED, or during a handover; ii) an RRC Setup message received by the UE during the transition from RRC_IDLE to RRC_CONNECTED or during a fallback from RRC_INACTIVE to RRC_IDLE or during re-establishment; iii) an RRC Resume message, received by the UE during the transition from RRC_INACTIVE to RRC_CONNECTED. In all these examples, the UE is meant to perform the monitoring and reporting in RRC_CONNECTED.

In one set of embodiments, the UE receives the configuration for the ML-model performance monitoring in a message in which the UE transitions to RRC_IDLE or RRC_INACTIVE. When the UE transitions to RRC_IDLE or RRC_INACTIVE the UE starts to perform the monitoring of the ML-model performance and, when the UE transitions to RRC_CONNECTED (e.g., upon reception of an RRC resume message) it may be configured to perform periodic report of the ML-model performance, which is available at the UE.

In one set of embodiments, the report of the ML-model performance is configured to be transmitted over PUCCH. In one embodiment, that is included within one or more CSI report(s).

In one set of embodiments, the report of the ML-model performance is configured to be transmitted over PUSCH. In one embodiment, that is included within one or more CSI report(s).

In one embodiment, the report of the ML-model performance is transmitted in an RRC message.
In one embodiment, the report is included in a UE assistance information message (e.g., UEAssistanceInformation) e.g., if the performance of the ML-model is worse than a pre-defined or configurable value.
In one embodiment, the report is included in a UE assistance information message (e.g., UEAssistanceInformation) e.g., if the performance of the ML-model is better than a pre-defined or configurable value, after it was worse.
In one embodiment, the report is included in an RRC Measurement Report, transmitted periodically or upon the triggering of an event (e.g., an Ax event, Bx, x=1, . . . , 6, . . . K, at least for the events defined in TS 38.331); In this case, ML-model performance information may be provided from the network node receiving the measurement report (e.g., source network node) to the target network node during a handover preparation, within a Handover Request message. Thus, the target network node may determine to keep, release of modify the configuration of the ML-model e.g., based on the reported performance information and/or to keep, release of modify the configuration of the ML-model performance monitoring functionality.
In one embodiment, the report from the UE is included in a UE Information Response message (e.g., UEInformationResponse). That is transmitted by the UE upon request from the network, wherein the received request is an indication a UE Information Request message (e.g., UEInformationRequest).
In one embodiment, before the UE receives the request, the UE transmits an indication that it has available one or more indications of the ML-model performance, wherein that is transmitted in an RRC Resume Complete message (or RRC Resume Request, or multiplexed with an RRC Resume Request) when the UE transitions from RRC_INACTIVE to RRC_CONNECTED. This may be applicable in case the UE has been performing the monitoring of the ML-model performance while it was in RRC_INACTIVE.
In one embodiment, before the UE receives the request, the UE transmits an indication that it has available one or more indications of the ML-model performance, wherein that is transmitted in an RRC Reconfiguration Complete message when the UE transitions from RRC_IDLE to RRC_CONNECTED. This may be applicable in case the UE has been performing the monitoring of the ML-model performance while it was in RRC_IDLE.

### On the Content of the ML-Model Performance Report

In certain embodiments, the ML-model performance report includes, one or more indications of at least one of the following parameters:
A value in percentage that indicates the confidence level of its ML-model outcome.
A confidence interval (where the confidence level can either also be included or e.g., specified in specification text).
An uncertainty level of the ML model output. For example, the uncertainty of a timing value in positioning (e.g., time of arrival (TOA) of signal from a transmit point (TP) as estimated by the UE); the uncertainty of the coordinates (x, y, z) at the output of UE's ML model; the uncertainty of the estimated UE velocity at the output of UE's ML model. Depending on the type of uncertainty, the uncertainty may take different type of units (e.g., nanoseconds for estimated timing; meters/centi-meters for estimated spatial coordinates; m/s for estimated velocity, etc). The granularity of the uncertainty can be specified as well (e.g., 10 nanoseconds; 10 centi-meters; 0.1 m/s, etc)
The statistic info of the data collected within a time window (e.g., data collected in one second starting from the time when receiving the request for ML-model performance reporting)
Indication that model output should, or should no longer be trusted (e.g., a single bit indication). Such signaling could also imply a switch to a non-ML algorithm by the UE and could be associated with the aforementioned metrics, e.g., that the signaling is triggered when exceeding a certain confidence level/interval. The definition of such metrics could be up to UE implementation, configured to the UE or provided by specification text.
Some form of identification on which ML-model or ML feature the ML-model performance report is associated to. This may be a direct link by some form of index or ID, or similar. It can also be based on which time/frequency or resource the report is sent on.
Indication that input data to the model is currently out-of-distribution (e.g., a single bit indication).
The ML model output
One or more bits indicating that the performance of the ML-model is worse than an acceptable level.
One or more bits indicating that the performance of the ML-model is better than an acceptable level.
Indicator from anomaly detection. For example, the subband recommended by UE's ML model has subband CQI values worse than full band CQI

The ML-model performance report can be sent as uplink control information report, MAC CE or as an RRC message, based on the configurations, events, and requests previously described.

### On the Usage of the ML-Model Performance Reports

Periodic ML-model performance reporting allows the network to regularly check whether the ML-model deployed at the UE is working properly. It also enables the network to collect and store the historical info about this ML-model running at the UE. Using these periodic ML-model performance reports, the NW can spot potential errors and inform the UE about this and/or enable/disable the UE to use the outcome of the ML-models for one or more procedures. This is especially helpful when the UE has limited memory and it cannot store large amount of historical data for advanced error analysis. Note that the NW may also request aperiodic reports rather frequently or even on a periodic basis to do the same purpose. The reason for requesting aperiodic reports may be that the aperiodic reports contain more information than the periodic reports.

In certain embodiments, the network node stores the received periodical ML-model performance report, detects a potential error(s) of in the ML-model, and then feeds back such info to the UE to assist its ML-model error analysis or trigger its ML-model retraining and update.

Based on the ML-model performance analysis, the NW decides and signals to the UE, e.g., to stop using the ML model, and/or start/re-start using the classical non-ML-algorithm/function, and/or to perform ML-model retraining/update, and/or activate an ML model (from operating a non-ML algorithm), and/or to switch to another ML model. The NW may adjust its transmission/reception decisions, e.g., the selection of the downlink/uplink transmission rank, the downlink modulation and coding scheme, and/or MU-MIMO co-scheduling with other UEs. The action(s) may (or may not) be transparent to the UE, in the sense that the NW may (or may not) inform the UE of the reasons for certain of the aforementioned adjustments.

Examples of actions that the NW can take based on a performance report indicating bad performance when considering ML-models for to CSI feedback, in, e.g., joint inference and reporting, are:
The NW may decide to schedule the UE for SU-MIMO transmission instead of co-scheduling it for MU-MIMO, since the SINR situation of the reporting UE, if doing MU-MIMO, is more uncertain.
If the NW co-schedules UE, with low confidence in the report, for MU-MIMO, then the NW may allow larger changes to the suggested precoding vectors for UE than for UEs with higher confidence in their respective reports. The NW may also change the modulation and coding scheme, as well as the number of transmission layers to appropriately reflect these changes.

In these examples the UE is informed of the decisions by the NW via the DL scheduling assignments and the effective channel(s) as estimated from DMRS. In this case the action is transparent to the UE since the latter is not explicitly informed of why the NW took these decisions.

In certain embodiments, the network node receiving the report is a Distributed Unit and/or baseband unit (e.g., gNodeB-DU), e.g., in case the report is transmitted by the UE in a MAC CE and/or CSI report (over L1-PUCCH/PUSCH). In response, the Distributed Unit and/or baseband unit (e.g., gNodeB-DU) transmits the report to a Centralized Unit (e.g., gNodeB-CU).

Note that even though the certain examples given in the present disclosure focus mainly on the UE reporting aspects over the Uu interface, the same methodologies can be applied for supporting ML model performance monitoring using signalling between different UEs over the PC5 interference. In that case, slidelink related physical signals/channels and configurations can be utilized and enhanced to support the model update related signalling between UEs. Examples of these signals/channels include PC5 connection establishment procedure, sidelink control information (SCI), physical sidelink control channel (PSCCH), physical sidelink shared channel (PSSCH), physical sidelink feedback channel (PSFCH).

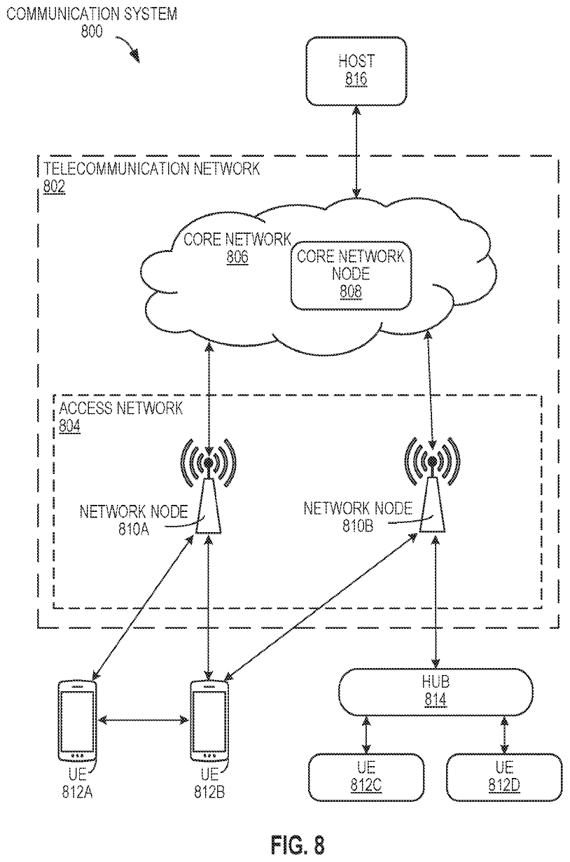

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3^{rd} Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

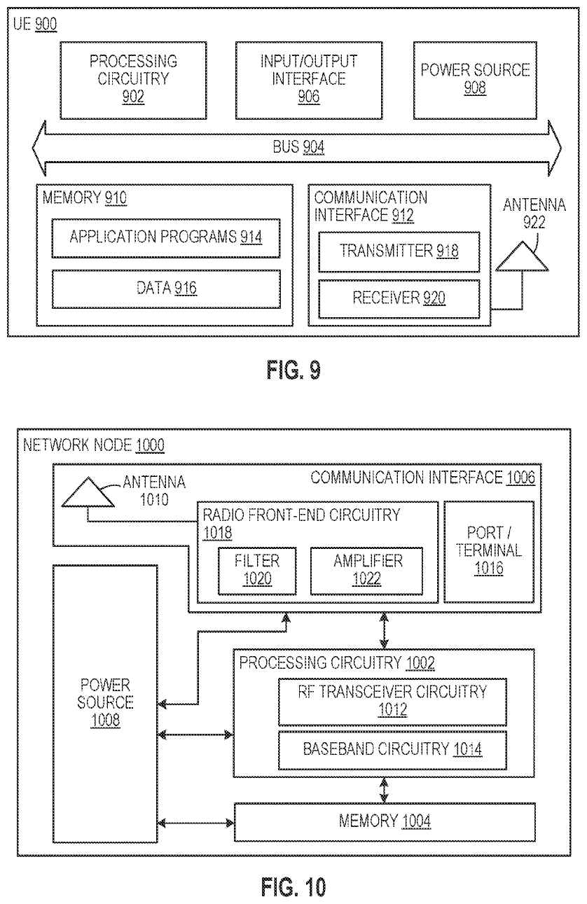

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900, such as the UE of FIG. 2, includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000, also shown in FIG. 2, in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

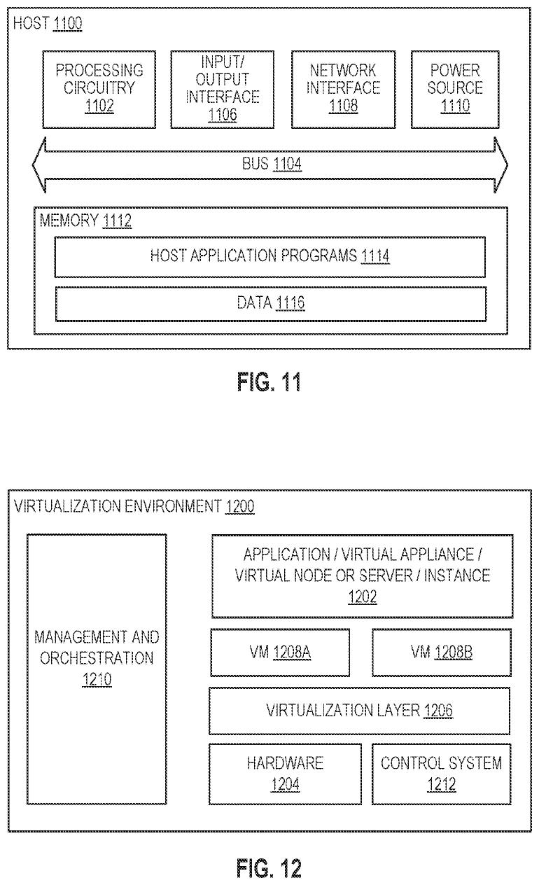

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g., such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

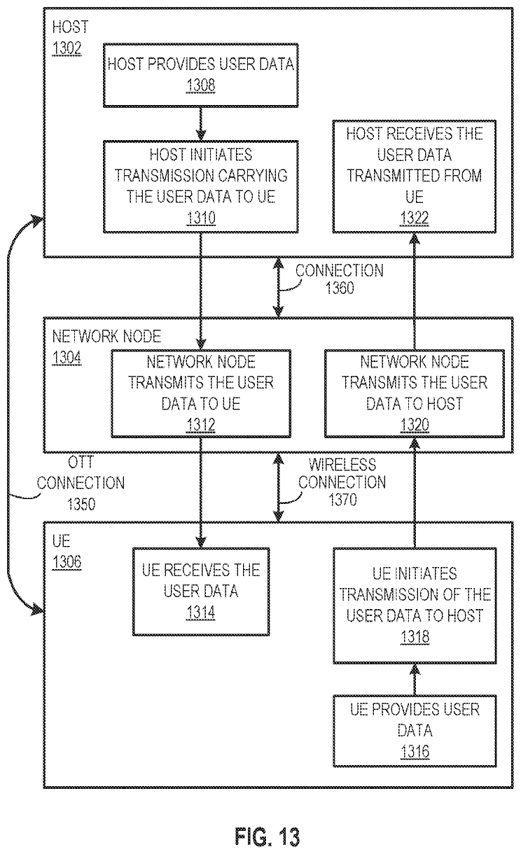

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the data rate, latency, and/or power consumption, and thereby provide benefits such as reduced user waiting time, relaxed restriction on file size, improved content resolution, better responsiveness, and/or extended battery lifetime.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

Some of the abbreviations used herein include:
DL Downlink
DMRS Demodulation reference signals
ML Machine learning
NW Network
SINR Signal to interference and noise ratio
UE User equipment
UL Uplink

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXEMPLARY EMBODIMENTS

### Group A Embodiments

1. A method performed by a user equipment (UE) for reporting one or more reports of a performance of at least one machine learning model to a network, the method comprising:
applying at least one machine learning model; and
generating one or more reports or reportable information of a performance of the at least one machine learning model; and
reporting the one or more reports or reportable information to a network.

2. The method of embodiment 1 wherein the reporting is based on one or more rules or trigger events.

3. The method of embodiment 2 wherein the one or more rules or trigger events comprise specification rules that trigger the UE to send an aperiodic report.

4. The method of any of embodiments 1-3 wherein the one or more rules or trigger events comprise specification signaling to indicate to the network that the machine learning model is not functioning within certain performance bounds.

5. The method of embodiment 1 further comprising:
receiving one or more configurations from a network node;
reporting by the UE the one or more reports of a performance of the at least one machine learning model based on the one or more configurations.

6. The method of embodiment 5 wherein the one or more configurations comprise configuring the UE to perform one or more reports in a periodic manner.

7. The method of embodiment 5 wherein the one or more configurations comprise configuring the UE to perform one or more reports in an aperiodic manner.

8. The method of embodiment 5 wherein the one or more configurations comprise configuring the UE to perform one or more reports in response to a detected performance drift of the machine learning model.

9. The method of any of embodiments 1-8 wherein the one or more reports comprise at least one or more of: a value in percentage that indicates a confidence level of its machine learning model output; a confidence interval; an uncertainty level of the machine learning model output; a statistic info of the data collected within a time window; an indication that model output should, or should no longer be trusted/valid; an identification on which ML-model or ML feature the ML-model performance report is associated to; an indication that input data to the model is currently out-of-distribution.

10. The method of any of embodiments 1-9 wherein the one or more reports are reported for one or more granularities.

11. The method of embodiment 10 wherein the one or more granularities comprise one or more of: one or more frequency ranges; one or more sub-bands; one or more sets of sub-bands; one or more Bandwidth Parts; one or more cells; one or more reference signal beams; one or more UE speeds.

12. The method of any of embodiments 1-11 wherein the one or more reports are sent with at least one of the following: machine learning model output; other messages; a CSI report.

13. The method of any of embodiments 1-12 wherein the one or more configurations are related to one or more functionalities and are configured to trigger one or more action depending on the one or more functionalities.

14. The method of any of the previous embodiments, further comprising indicating to the network a capability of the machine learning model.

15. The method of embodiment 14 wherein the capability comprises an indication of one or more reporting methods for the machine learning model performance that the UE supports.

16. The method of any of the previous embodiments, wherein the at least one machine learning model is configured by the network in at least one of the following: model architecture, hyperparameters, loss function, reward.

17. The method of any of the previous embodiments wherein at least one of the following is pre-defined or applied with default settings: model architecture, hyperparameters, loss function, reward, action set.

18. The method of any of the previous embodiments wherein the UE operates with that at least one machine learning model deployed at the UE.

19. The method of any of the previous embodiments wherein at least one of the one or more reports is requested by the network.

20. The method of any of the previous embodiments further comprising performing analysis or monitoring of performance of the machine learning model.

21. The method of any of the previous embodiments, further comprising:
providing user data; and
forwarding the user data to a host via the transmission to the network node.

### Group B Embodiments

22. A method performed by a network node for receiving one or more reports of a performance of at least one machine learning model applied by a UE, the method comprising:
receiving, from a UE, one or more reports of the performance of the at least one machine learning model.

23. The method of embodiment 22 further comprising performing an analysis of machine learning model performance based at least in part on the one or more reports.

24. The method of any of embodiments 22-23 further comprising commanding the UE to stop using the machine learning model.

25. The method of any of embodiments 22-23 further comprising commanding the UE to start or re-start using a classical non-machine learning model.

26. The method of any of embodiments 22-23 further comprising commanding the UE to train or retrain the machine learning model.

27. The method of any of embodiments 22-26 further comprising deciding how much to rely on the one or more reports in making transmission or reception decisions.

28. The method of any of embodiments 22-27 further comprising signaling to the UE one or more configurations of the UE report(s) or the machine learning model.

29. The method of embodiment 28 wherein the one or more configurations comprises at least one or more of: machine learning models and/or machine learning features to periodically report performance for; machine learning models and/or machine learning features to aperiodically report performance for; a validity of a length of the one or more reports; whether the one or more reports should cover multiple serving cells or only a serving cell; contents of the one or more reports; a time window of the one or more reports; if generating reports should be stopped or suspended when the UE transitions to RRC IDLE and/or RRC INACTIVE STATE from RRC_CONNECTED STATE; if the one or more reports should be generated both in DRX and non-DRX operation; whether to stop when UL timing alignment is lost; information on which resources in time, frequency and/or code domain the one or more reports are to be sent; information for which time instance or instances the one or more reports should cover; information about the periodicity and time domain offset of the one or more reports; information about one or more PUCCH resources to use for reporting on PUCCH; the reporting quantity for the machine learning model in case of multiple performance metrics.

30. The method of 28 wherein the one or more configurations is done by one or more of: RRC, MAC CE, and L1 signaling.

31. The method of any of embodiments 22-23 further comprising commanding the UE to update the at least one machine learning model.

32. The method of any of embodiments 22-23 further comprising commanding the UE to switch from the at least one machine learning model to a different at least one machine learning model.

33. The method of any of the previous embodiments, further comprising:
obtaining user data; and
forwarding the user data to a host or a user equipment.

### Group C Embodiments

34. A user equipment (UE) for performing a machine learning model and reporting to a network, comprising:
processing circuitry configured to perform any of the steps of any of the Group A embodiments; and
power supply circuitry configured to supply power to the processing circuitry.

35. A network node for receiving one or more reports from a UE regarding performance of a machine learning model, the network node comprising:
processing circuitry configured to perform any of the steps of any of the Group B embodiments;
power supply circuitry configured to supply power to the processing circuitry.

36. A user equipment (UE) for performing a machine learning model and reporting to a network, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

37. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

38. The host of the previous embodiment, wherein the cellular network further includes a network node configured to communicate with the UE to transmit the user data to the UE from the host.

39. The host of the previous 2 embodiments, wherein:
the processing circuitry of the host is configured to execute a host application, thereby providing the user data; and
the host application is configured to interact with a client application executing on the UE, the client application being associated with the host application.

40. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

41. The method of the previous embodiment, further comprising:
at the host, executing a host application associated with a client application executing on the UE to receive the user data from the UE.

42. The method of the previous embodiment, further comprising:
at the host, transmitting input data to the client application executing on the UE, the input data being provided by executing the host application,
wherein the user data is provided by the client application in response to the input data from the host application.

43. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

44. The host of the previous embodiment, wherein the cellular network further includes a network node configured to communicate with the UE to transmit the user data from the UE to the host.

45. The host of the previous 2 embodiments, wherein:
the processing circuitry of the host is configured to execute a host application, thereby providing the user data; and
the host application is configured to interact with a client application executing on the UE, the client application being associated with the host application.

46. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

47. The method of the previous embodiment, further comprising:
at the host, executing a host application associated with a client application executing on the UE to receive the user data from the UE.

48. The method of the previous embodiment, further comprising:
at the host, transmitting input data to the client application executing on the UE, the input data being provided by executing the host application,
wherein the user data is provided by the client application in response to the input data from the host application.

49. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

50. The host of the previous embodiment, wherein:
the processing circuitry of the host is configured to execute a host application that provides the user data; and
the UE comprises processing circuitry configured to execute a client application associated with the host application to receive the transmission of user data from the host.

51. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

52. The method of the previous embodiment, further comprising, at the network node, transmitting the user data provided by the host for the UE.

53. The method of any of the previous 2 embodiments, wherein the user data is provided at the host by executing a host application that interacts with a client application executing on the UE, the client application being associated with the host application.

54. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

55. The communication system of the previous embodiment, further comprising:
the network node; and/or
the user equipment.

56. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

57. The host of the previous 2 embodiments, wherein:
the processing circuitry of the host is configured to execute a host application, thereby providing the user data; and
the host application is configured to interact with a client application executing on the UE, the client application being associated with the host application.

58. The host of the any of the previous 2 embodiments, wherein the initiating receipt of the user data comprises requesting the user data.

59. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

60. The method of the previous embodiment, further comprising at the network node, transmitting the received user data to the host.

Combinations of these embodiments are included within the scope of this disclosure.

1.-60. (canceled)

61. A method performed by a user equipment (UE) for reporting a performance of at least one machine-learning (ML) model to a network, the method comprising:
utilizing at least one ML model;
generating one or more reports or reportable information of a performance of the at least one ML model; and
reporting the one or more reports or reportable information to a network.

62. The method of claim 61, wherein the reporting is based on one or more rules or trigger events that trigger the UE to indicate to the network that the at least one ML model is not functioning within performance bounds.

63. The method of claim 61, further comprising:
receiving one or more configurations from a network node;
wherein the reporting is based on the one or more configurations.

64. The method of claim 63, wherein the one or more configurations comprise configuring the UE to perform the reporting in a periodic manner.

65. The method of claim 63, wherein the one or more configurations comprise configuring the UE to perform the reporting in an aperiodic manner.

66. The method of claim 63, wherein the one or more configurations comprise configuring the UE to perform the reporting in response to a detected performance drift of the at least one ML model.

67. The method of claim 61, wherein the one or more reports comprise at least one or more of:
a value indicating a confidence level associated with output of the at least one ML model;
a confidence interval;
an uncertainty level associated with the output of the at least one ML model;
a statistic associated with data collected within a time window;
an indication that the output of the at least one ML model should be, or should no longer be, trusted or valid;
an identification associating the one or more reports with the at least one ML model or with an ML feature; and
an indication that input data to the at least one ML model is currently out-of-distribution.

68. The method of claim 61, wherein the at least one ML model facilities one or more of: channel state information (CSI) prediction, beam management, and positioning.

69. The method of claim 61, wherein the one or more reports are reported for one or more granularities, the one or more granularities comprising one or more of: per frequency range; per sub-band; per set of sub-bands; per Bandwidth Part; per cell; per reference signal beam; and per UE speed.

70. The method of claim 61, wherein the one or more reports are sent to the network with at least one of the following:
output of the at least one ML model; or
a channel state information (CSI) report.

71. The method of claim 61, wherein the performance of the at least one ML model is monitored for different functionalities that trigger different actions.

72. The method of claim 61, further comprising:
indicating, to the network, a capability of the UE to analyze the performance of the at least one ML model.

73. The method of claim 61, further comprising:
indicating, to the network, one or more reporting methods that the UE supports for reporting the performance of the at least one ML model.

74. The method of claim 61, wherein the at least one ML model is configured by the network in at least one of the following aspects:
model architecture;
a parameter used to control a learning process of the at least one ML model; and
an optimization objective for the at least one ML model.

75. The method of claim 61, further comprising, in response to a command from the network, stop using the at least one ML model.

76. The method of claim 61, further comprising, in response to a command from the network, start or re-start using a non-ML model.

77. The method of claim 61, further comprising, in response to a command from the network, train or retrain the at least one ML model.

78. The method of claim 61, further comprising, in response to a command from the network, update the at least one ML model.

79. The method of claim 61, further comprising, in response to a command from the network, switch from the at least one ML model to a different at least one ML model.

80. A user equipment (UE) for performing a machine learning (ML) model and reporting to a network, comprising:
processing circuitry configured to perform operations comprising:
utilizing at least one ML model;
generating one or more reports or reportable information of a performance of the at least one ML model; and
reporting the one or more reports or reportable information to a network; and
power supply circuitry configured to supply power to the processing circuitry.
